(19) United States
(12) Patent Application Publication
(10) Pub. No.: US 2019/0041520 A1
(43) Pub. Date: Feb. 7, 2019

(54) LIDAR SYSTEM

(71) Applicant: Robert Bosch GmbH, Stuttgart (DE)

(72) Inventors: Ingo Ramsteiner, Stuttgart (DE); Annette Frederiksen, Renningen (DE); Tobias Graf, Stuttgart (DE)

(21) Appl. No.: 16/055,305

(22) Filed: Aug. 6, 2018

(30) Foreign Application Priority Data
Aug. 7, 2017 (DE) 102017213706.1

(51) Int. Cl. G01S 17/89; G01S 7/481

(52) U.S. Cl. CPC G01S 17/89; G01S 7/4817

(57) ABSTRACT

A LIDAR system which includes a laser radiation source for generating coherent laser radiation, the LIDAR system being designed for emitting the laser radiation emitted by the LIDAR system essentially in propagation modes which correspond to analytical solutions of the paraxial Helmholtz equation including two ordinal numbers, at least one of the two ordinal numbers being greater than 0.

### CROSS REFERENCE

The present application claims the benefit under 35 U.S.C. § 119 of German Patent No. DE 102017213706.1 filed on Aug. 7, 2018, which is expressly incorporated herein by reference in its entirety.

### FIELD

The present invention relates to a LIDAR system, preferably an eye-safe LIDAR system.

### BACKGROUND INFORMATION

LIDAR (Light Detection and Ranging) is becoming increasingly significant in the surroundings detection of motor vehicles or robots. Even though various technical specific embodiments exist, the presence, distance, and, if necessary, speed of other objects is generally detected by emitting light and subsequently detecting the radiation reflected by illuminated surfaces. In particular, a laser beam may be utilized for scanning the surroundings. A typical method is based on the approach that individual laser pulses are emitted in rapid succession by an appropriate LIDAR system in different spatial directions in order to scan the surroundings and the distance to the reflecting surface is determined with the aid of a time-of-flight measurement of the particular reflected pulses (time-of-flight measurement).

European Patent No. EP 0 648 340 B1 describes, for example, a LIDAR, with the aid of which an obstacle avoidance system for helicopters and aircraft may be implemented.

The range of a LIDAR system is limited, inter alia, by the fact that fewer and fewer photons return to the detector as the distance to a reflecting surface increases and, at some point, the detection of the photons and an evaluation of the reflected signal becomes no longer possible. Although the range may be increased by increasing the laser power, certain upper limits are involved here, however, because eye safety must always be ensured for all persons located in the range of the radiation. This is a critical limitation, in particular, at wavelengths in the visible and near infrared spectral ranges (wavelengths below 1.4 μm), because such light penetrates the cornea and the lens of the eye particularly well and, therefore, may be focused onto the sensitive retina. Due to the requirements on eye safety, the laser power may therefore not be arbitrarily increased.

In the case of coherent laser radiation having corresponding wavelengths, the risk to the eye lies, in particular, in the fact that the coherent light may be focused very well by the lens of the eye onto individual points of the sensitive retina.

As a result, very high power densities may occur at this point, which may irreversibly destroy the sensitive tissue of the retina. Although the use of incoherent laser radiation would increase the size of the effective focal point, such radiation, however, has a considerably higher divergence and, therefore, is not suitable for a high-resolution scanning of the surroundings.

### SUMMARY

According to the present invention, a LIDAR system is made available, which avoids or at least considerably reduces the problems occurring in the related art regarding the eye safety of coherent laser radiation at high powers. The LIDAR system according to the present invention is preferably a non-coherently detecting LIDAR. In the case of such a LIDAR, the phase (or the phase relation within the radiation field) of the laser radiation utilized for scanning the surroundings will not be taken into consideration.

A LIDAR system according to the present invention includes a laser radiation source for generating coherent laser radiation, the LIDAR system being designed for emitting the laser radiation emitted by the LIDAR system essentially in propagation modes (also referred to as transversal propagation modes) which correspond to analytical solutions of the paraxial Helmholtz equation including two ordinal numbers, at least one of the two ordinal numbers being greater than 0. In contrast to basic modes, in which the two ordinal numbers are equal to 0, the aforementioned modes are also referred to as higher-order propagation modes (i.e., at least one order higher than the basic mode). The radiation emitted by the LIDAR system is preferably monochromatic, i.e., essentially established at one single wavelength. In particular, the laser radiation source may be a longitudinal single mode emitter (only one longitudinal propagation mode).

The paraxial Helmholtz equation is an approximative form of the Helmholtz equation, which results from the general wave equation after separating the variables and assuming a harmonic time dependence. The paraxial Helmholtz equation may be utilized, in particular, for describing the propagation of coherent laser radiation.

Analytical solutions may typically be found by developing the solution space in a complete set of orthogonal eigenfunctions for certain geometric boundary conditions. Such a set of solutions is also referred to as a mode family. Since the lateral component of the paraxial Helmholtz equation is, mathematically, a two-dimensional problem (field distribution in a plane perpendicular to the propagation direction), appropriate solutions may be described with the aid of two mutually independent lateral parameters. If each member of the mode family may be represented as a lateral parameter by a pair of whole numbers, these numbers are referred to as ordinal numbers for the corresponding mode family, the order of the corresponding solution or of the particular eigenfunctions being established in this way.

The ordinal numbers may also be taken directly from the intensity profile of a corresponding beam, since the number of field maxima occurring in certain directions correlates with the level of the order, i.e., with the values of the corresponding ordinal numbers. The basic mode of a mode family is distinguished by the fact that a straight line through the beam profile in an arbitrary direction points precisely to an intensity maximum in the beam center (for example, an ideal Gaussian profile). Higher-order modes are distinguished by the fact that a different number of local field or intensity maxima may be established at least for individual intersection lines and/or, along such an intersection line, the centroid of the field distribution lies outside the beam center.

The boundary conditions mostly establish a particularly preferred coordinate system for the selection of the eigenfunctions. In accordance with these boundary conditions, the problem may then be transformed into a corresponding coordinate system. For example, a typical Gaussian beam is one solution of the paraxial Helmholtz equation in cylindrical coordinates having circular boundary conditions.

Real laser radiation or beam profiles which may be generated in any other way may mostly be well approximated by individual solutions (for example, an ideal Gaussian beam) or a superposition of solutions of a mode family. Due to the completeness of the development, any arbitrary field distribution, in principle, may be approximated for a superposition including a large number of independent solutions of a mode family. Nevertheless, a limitation of the superposition to, at most, three propagation modes of a mode family is mostly completely sufficient for an approximation of a real laser radiation. In this case, it is considered to be sufficient when the propagation modes under consideration preferably include at least 80%, more preferably at least 90%, more preferably at least 95%, and even more preferably at least 99% of the total radiant power of the real laser radiation.

The fact that the laser radiation emitted by the LIDAR system essentially propagates in certain propagation modes therefore means that the propagation modes propagating according to the present invention (i.e., the essential propagation modes) preferably include at least 80%, more preferably at least 90%, more preferably at least 95%, and even more preferably at least 99% of the total radiant power emitted by the LIDAR system.

### SUMMARY

An example LIDAR system according to the present invention may have the advantage that, due to a coherent laser radiation propagating essentially in higher propagation modes, the focusability of the radiation, even with the aid of optical units, is substantially reduced as compared, for example, to the Gaussian beam of a basic mode emitter. Corresponding modes, when passing through a lens, are not imaged on a single sharp point, but rather on an intensity distribution which deviates therefrom and includes a larger area. In particular, during the imaging of the radiation source onto the retina, a coherent laser radiation, which has been focused through the lens of the eye of an observer, for corresponding propagation modes is imaged in a manner which is “fuzzier” than if an ideal Gaussian beam were utilized.

As a result, the focused radiation power is distributed onto a larger area of the retina, so that the radiation exposure per surface element is reduced by comparison (lower power density). Therefore, the destruction threshold of the tissue is first reached locally at higher total powers than is the case for a Gaussian beam. This may be utilized for operating a LIDAR system according to the present invention in an eye-safe manner despite an increased laser power as compared to the related art.

By utilizing special beam profiles (i.e., corresponding propagation modes), a greater angular subtense of the apparent source on the retina may therefore be achieved, whereby the accessible emission limits (AEL) predefined by the eye safety standard IEC 60825-1 may be increased. In addition, during the imaging of these special beam profiles, the output received by the eye is distributed onto a larger area, whereby the quotient AE/AEL (AE=accessible emission) becomes smaller. Therefore, eye-safe systems having an increased transmission power may be implemented, which, in turn, positively affects the performance (range) of the systems.

The fact that a lens focuses incident light onto a single point of the image plane is actually a special case for plane waves. Laser beams having a Gaussian beam profile (the norm) include actually planar wave fronts in the beam waist, however, and, at other points, correspond to spherical waves having an extremely large radius of curvature, which are therefore also approximately planar across and beyond a pupil. The assumption of planar waves is therefore justified.

The propagation modes utilized according to the present invention may preferably be Hermite-Gaussian modes, Laguerre-Gaussian modes, or Ince-Gaussian modes. These are well-known solutions (each forming a mode family) of the paraxial Helmholtz equation for different boundary conditions (complete sets of orthogonal eigenfunctions). In particular, these are analytical solutions of the paraxial Helmholtz equation including two ordinal numbers, each of the two ordinal numbers being equal to 0 for the particular basic modes.

Hermite-Gaussian modes are a family of stable solutions to the paraxial Helmholtz equation having a rectangular radiation cross section (corresponds to rectangular boundary conditions) along the propagation direction of the radiation. Hermite-Gaussian modes may be represented as analytical solutions of the paraxial Helmholtz equation in Cartesian coordinates with the aid of the product of two Hermite polynomials Hₗ×Hₘ. Individual Hermite-Gaussian modes are typically abbreviated as HG_{l,m} including two ordinal numbers l and m (l and m encompass the amount of the non-negative whole numbers).

Laguerre-Gaussian modes are a family of stable solutions to the paraxial Helmholtz equation having a circular radiation cross section (corresponds to circular boundary conditions) along the propagation direction of the radiation. Laguerre-Gaussian modes may be represented as analytical solutions of the paraxial Helmholtz equation in cylindrical coordinates with the aid of the assigned Laguerre polynomials Lₚ^{l}. Individual Laguerre-Gaussian modes are typically abbreviated as LG_{p, l} including two ordinal numbers p and l (p and l encompass the amount of the non-negative whole numbers). The assigned Laguerre polynomials Lₚ^{l} may be represented, with the aid of the simple Laguerre polynomials, as

$${L}_{p}^{′} ( x ) = {( - 1 )}^{l} \frac{{d}^{l}}{{dx}^{l}} {L}_{p + l} ( x ) .$$

Preferably, the propagation modes are LG_{p, l} Laguerre-Gaussian modes, where p is equal to 0 and l is greater than 0. As a result, rings form and the intensity per surface element in the formed rings is approximately constant. Therefore, an estimation of the radiation intensity per area becomes considerably simpler than in the case of an additional azimuthal variation of the intensity profile. It is further preferred that the laser radiation emitted by the LIDAR system propagates essentially in one single propagation mode (i.e., transversally monomodal). In particular, this may be a Laguerre-Gaussian mode abbreviated as LG_{0,1}, including the ordinal numbers p equal to 0 and 1 equal to 1. Further preferred is the utilization of a Laguerre-Gaussian mode abbreviated as LG_{0, 2}, LG_{0, 3}, LG_{0,4} or LG_{0,5} for scanning the surroundings. One aspect shared by all the modes indicated in this paragraph as being preferred is that the intensity assumes a minimum in the beam center and is otherwise circularly distributed about the beam center. During a focusing of the radiation, the intensity is also spatially (on the retina) distributed and therefore also does not assume a dangerous punctiform maximum (as in the case of a Gaussian beam).

Ince-Gaussian modes are a family of stable solutions to the paraxial Helmholtz equation having an elliptical radiation cross section (corresponds to elliptical boundary conditions) along the propagation direction of the radiation. An analytical description may take place with the aid of the Ince polynomials Cₚ^{m}, also with the aid of two ordinal numbers p and m. Individual Ince-Gaussian modes are typically abbreviated as IG_{p,m}.

Preferably, the laser radiation emitted by the LIDAR system propagates essentially in one single propagation mode. As a result, the effort for generating the desired beam profile may be kept low.

If the utilized laser radiation source itself does not already yield propagation modes corresponding to the present invention (for example, has an appropriate resonator geometry), there are various possibilities for generating appropriate propagation modes. Frequently, the case of a Gaussian beam may be assumed as a starting profile of the laser radiation source, which is transformed, before a transmission, within the LIDAR system according to the present invention with the aid of an appropriate means for carrying out the transformation or with the aid of a plurality of appropriate means.

Preferably, the laser radiation generated by the laser radiation source is transformed into the propagating propagation modes with the aid of a diffractive optical element (DOE) or a hologram. These means for carrying out the transformation are to be produced, first and foremost, in a particularly reasonably priced manner. In particular, the so-called pitchfork holograms are particularly preferred in this case, since they generate pure Laguerre-Gaussian beams in the diffraction order, while incompletely converted light components (planar waves) are transmitted in the zeroth order and may be captured with the aid of a beam trap. They are particularly eye-safe due to the fact that they no longer generate any beam at all in the diffraction direction if they become damaged. It is possible to also focus using the same element by placing a Fresnel lens over the element.

A transformation of the laser radiation generated by the laser radiation source with the aid of a spiral phase plate or a vortex lens is also possible. These commercially available means for carrying out the transformation offer, depending on the quality, a very high conversion efficiency—though relatively expensive—precisely tuned to the particular wavelength and therefore require a highly precise tuning to the rest of the LIDAR system.

The transformation of the laser radiation generated by the laser radiation source with the aid of a cylindrical lens, an SLM, or Q plates, is also possible. However, these methods are mostly impracticable, inefficient, or very expensive.

Yet another aspect of the present invention relates to a motor vehicle including a LIDAR system according to the present invention, the LIDAR system being connected to a control system of the motor vehicle. The control system of a vehicle is understood to be, in this case, in particular, an electronic control system for the monitoring, regulation, and control of the instantaneous vehicle state. Yet another aspect of the present invention relates to a motor vehicle including a LIDAR system according to the present invention, the LIDAR system being utilized for scanning the surroundings in an eye-safe manner.

Advantageous refinements of the present invention are stated in the subclaims and are described in the description.

### BRIEF DESCRIPTION OF THE DRAWINGS

Exemplary embodiments of the present invention are described in greater detail with reference to the figures in the description below.

FIG. 1 shows phase fronts of collimated beams and intensity distributions after focusing, using the example of a Gaussian beam (top) and a higher-order Laguerre-Gaussian beam according to the present invention (bottom).

FIG. 2 shows a schematic representation of a phase distribution in relation to an eye.

FIG. 3 shows a simulation of the retinal images for the far accommodation of an eye.

### DETAILED DESCRIPTION OF EXAMPLE EMBODIMENTS

FIG. 1 shows phase fronts of collimated beams and intensity distributions after focusing, using the example of a Gaussian beam (top) and a higher-order Laguerre-Gaussian beam according to the present invention (bottom). Moreover, a LIDAR system including a laser radiation source 10 for generating coherent laser radiation 12 is schematically represented, generated laser radiation 12 being focused onto an image plane by a lens 22 in the further progression of the beam. In particular, lens 22 may be lens of an eye 20 and image plane 24 may be a corresponding retina 24.

The particular phase fronts (phase distribution) before the focusing are represented for the cutting plane indicated close to the LIDAR system and the corresponding intensity distributions in the image plane after the focusing are represented for the cutting plane indicated far from the LIDAR system. The upper row shows typical distributions for a Gaussian beam of a conventional LIDAR system. The lower row shows typical distributions for a first-order Laguerre-Gaussian beam of the type which is also utilized in one particularly preferred specific embodiment of a LIDAR system according to the present invention. In particular, the represented propagation mode may be a LG_{C, 5} Laguerre-Gaussian mode as the analytical solution of the paraxial Helmholtz equation in cylindrical coordinates using assigned Laguerre polynomials including ordinal numbers p equal to 0 and 1 equal to 5.

A conventional Gaussian beam includes essentially planar wave fronts and is imaged onto a single point during the focusing. By comparison, in the case of the represented Laguerre-Gaussian mode, an annular intensity distribution forms around the focal point, due to the helical wave front apparent in the phase distribution. The irradiated optical power is therefore distributed onto a larger area of retina 24, whereby the occurrence of optical radiation damage may be prevented.

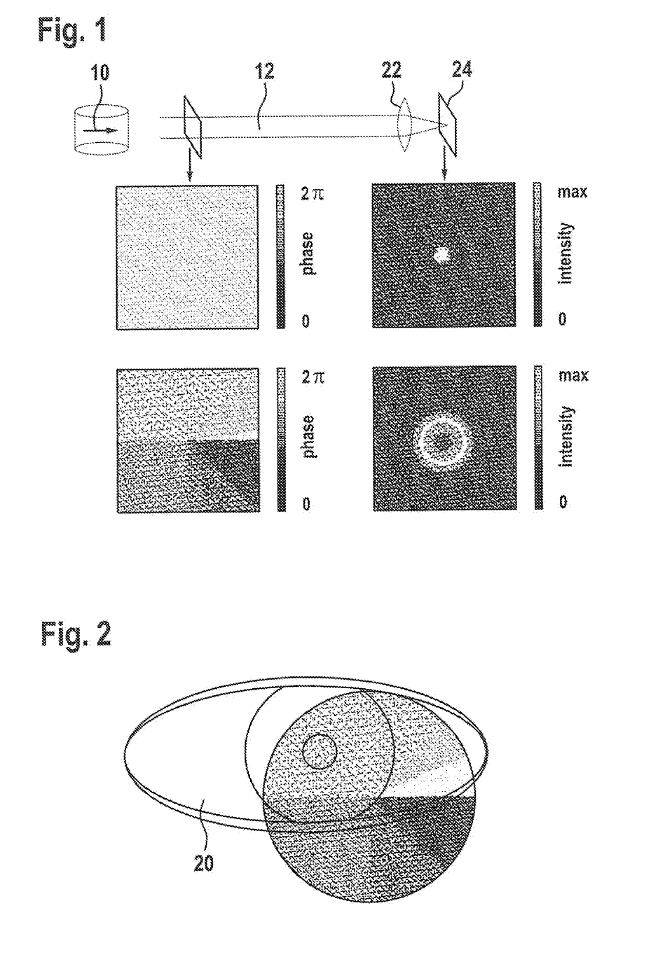

FIG. 2 shows a schematic representation of a phase distribution in relation to an eye 20. The represented phase distribution corresponds to the phase distribution represented in FIG. 1 for a higher-order Laguerre-Gaussian beam according to the present invention. As described, in the case of the represented Laguerre-Gaussian mode, an annular intensity distribution forms on retina 24 during an imaging through lens 22 due to the helical wave front apparent in the phase distribution. The absence of intensity in the center is a consequence of the fact that all phases from 0 to 2π interfere there. This effect is retained for as long as the aforementioned vortex is part of the captured wave front.

In the case, in particular, of a large beam cross section (large as compared to the pupil of eye 20), it may happen that the vortex does not strike the pupil, as represented here. In this case, the pupil captures only a portion of the beam cross section, the phase singularity of the beam possibly not being contained therein. As a result, eye 20 sees a relatively homogeneous (possibly linearly varying) wave front which is essentially imaged again onto a single point of retina 24. In this case, however, the total intensity captured by retina 24 also amounts to only a fraction of the intensity of the total beam. In the extreme case (vortex lies precisely on the edge of the pupil), only just one-half of the intensity is imaged onto retina 24. The remaining radiation is absorbed by eye 20 and its immediate surroundings. The requirements on eye safety may therefore be met even in the event of an incomplete imaging of laser radiation 12 of a LIDAR system according to the present invention.

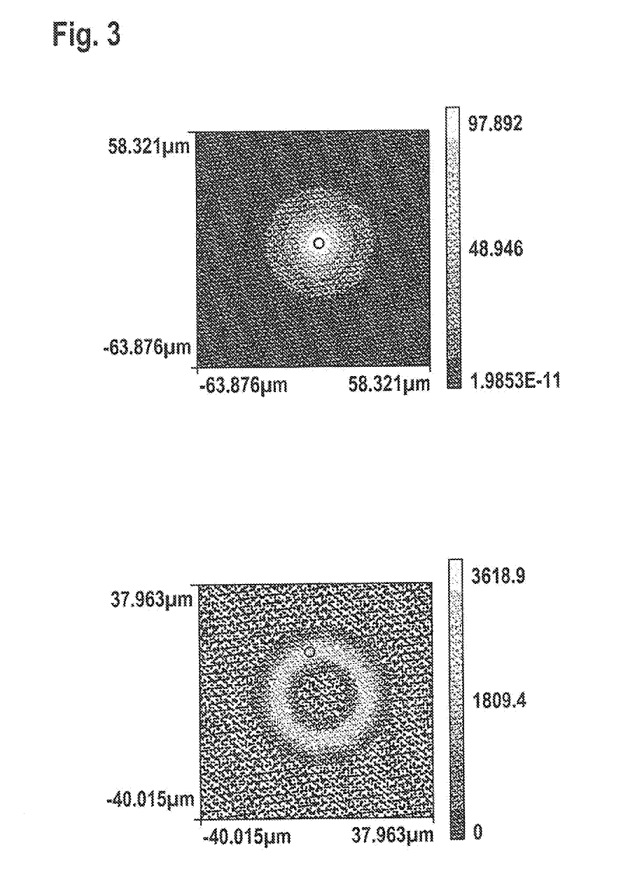

FIG. 3 shows a simulation of the retinal images for the far accommodation of an eye 20. In this case, the typical imaging parameters of an eye 20 and the relevant standards for eye safety were utilized in order to create the simulation environment and, subsequently, a corresponding wave-optical simulation was carried out.

The standards (IEC 60825-1, DIN EN 60825-1) predefine accessible emission limits (AEL) for the various laser classes, which must not be exceeded by a laser system of the particular class. The laser class 1 is significant, in particular, with respect to LIDAR systems, since laser class 1 allows for an eye-safe system. Class 2 may be utilized only for the visible spectral range and, with respect to class 3, it may not be assumed that the system will not cause damage in the event of longer gazing into the beam. In the evaluation of eye safety, all distances, all positions in the field-of-view (FOV) of the LIDAR sensor, all accommodation states of eye 20, and all temporal subsections of the pulse pattern up to 100 s striking eye 20 must be considered.

If pulsed systems are involved, the three pulse criteria predefined by the standards must also be evaluated. Since this calculation is highly complex for real systems, only one beam (that is, one single pulse) is mostly considered. With respect to eye safety, the pupil of eye 20 is assumed to be 7 mm (maximally dilated pupil) and the accommodation bandwidth of eye 20 may be assumed, in the case of ideal lens 22, to be the focal length 14.5 mm to 17 mm, given a distance of the retina to lens 22 of 17 mm. The angular subtense of the apparent source is understood to be the angle at which a source appears from a certain point in space. The accommodation state was set with the focus to infinity. The far accommodation is the most critical range, since the smallest images form on retina 24 in this case.

The figure on the left shows the retinal imaging of a Gaussian beam of a conventional LIDAR system. The figure on the right shows a corresponding retinal imaging of a Laguerre-Gaussian beam of a LIDAR system according to the present invention. In particular, the simulated propagation mode is a LG_{0, 5} Laguerre-Gaussian mode including ordinal numbers p equal to 0 and 1 equal to 5. The retinal images shown correspond to a lens focal length of 17 mm.

The diameters of the resultant retinal imagings are approximately of equal size for the two beams. With respect to eye safety, it is not the size of the image that matters, however, but rather the intensity distribution within the retinal imaging. In order to carry out a comprehensive evaluation of eye safety, all possible subregions of an imaging on retina 24, in particular in the regions of maximum intensity, must therefore be evaluated. The great advantage of the Laguerre-Gaussian beams becomes apparent in this case. In the case of the normal Gaussian beam, 3.96% of the total power is located in the subregions represented by way of example, while the amount is only 0.55% in the Laguerre-Gaussian case. As a result, the quotient AE/AEL is considerably lower in the Laguerre-Gaussian case (note: AE/AEL must be <1 so that the system meets the requirement of the laser class).

What is claimed is:

1. A LIDAR system, comprising:
a laser radiation source to generate coherent laser radiation;
wherein the LIDAR system is designed for emitting the laser radiation emitted by the LIDAR system essentially in propagation modes which correspond to analytical solutions of the paraxial Helmholtz equation including two ordinal numbers, at least one of the two ordinal numbers being greater than 0.

2. The LIDAR system as recited in claim 1, wherein the propagation modes are Hermite-Gaussian modes, Laguerre-Gaussian modes, or Ince-Gaussian modes.

3. The LIDAR system as recited in claim 1, wherein the propagation modes are Laguerre-Gaussian modes as stable solutions of the paraxial Helmholtz equation in cylindrical coordinates using the assigned Laguerre polynomials Lₚ^{l} including ordinal numbers p and l, p being equal to 0 and l being greater than 0.

4. The LIDAR system as recited in claim 1, wherein the laser radiation emitted by the LIDAR system propagates essentially in one single propagation mode.

5. The LIDAR system as recited in claim 4, wherein the propagation mode is a Laguerre-Gaussian mode as a stable solution of the paraxial Helmholtz equation in cylindrical coordinates using an assigned Laguerre polynomial Lₚ^{l} including ordinal numbers p equal to 0 and l equal to 1, 2 or 3.

6. The LIDAR system as recited in claim 1, wherein the laser radiation generated by the laser radiation source is transformed into the propagating propagation modes with the aid of a diffractive optical element or a hologram.

7. The LIDAR system as recited in claim 1, wherein the laser radiation generated by the laser radiation source is transformed into the propagating propagation modes with the aid of a spiral phase plate or a vortex lens.

8. The LIDAR system as recited in claim 1, wherein the laser radiation generated by the laser radiation source is transformed into the propagating propagation modes with the aid of a cylindrical lens, an SLM, or Q plates.

9. The LIDAR system as recited in claim 1, wherein the propagation modes include at least 80% of a total radiated power emitted by the LIDAR system.

10. A motor vehicle including a LIDAR system and a control system of the motor vehicle, the LIDAR system being connected to the control system of the motor vehicle, the LIDAR system comprising:
a laser radiation source to generate coherent laser radiation;
wherein the LIDAR system is designed for emitting the laser radiation emitted by the LIDAR system essentially in propagation modes which correspond to analytical solutions of the paraxial Helmholtz equation including two ordinal numbers, at least one of the two ordinal numbers being greater than 0.
